(19) United States
(12) Patent Application Publication
(10) Pub. No.: US 2024/0320335 A1
(43) Pub. Date: Sep. 26, 2024

(54) DETECTION OF RANSOMWARE ACTIVITY BASED ON OS PAGINATION FUNCTIONALITY

(71) Applicant: Dell Products L.P., Round Rock, TX (US)

(72) Inventors: Ofir Ezrielev, Be'er Sheba (IL); Yehiel Zohar, Sderot (IL); Yevgeni Gehtman, Modi'in (IL); Tomer Shachar, Beer-Sheva (IL); Maxim Balin, Gan-Yavne (IL)

(21) Appl. No.: 18/188,625

(22) Filed: Mar. 23, 2023

(51) Int. Cl. G06F 21/56

(52) U.S. Cl. CPC G06F 21/566

(57) ABSTRACT

One example method includes monitoring pagination operations of an operating system, collecting information about the pagination operations, analyzing the information about the pagination operations, and based on the analyzing, determining whether any of the pagination operations are indicative of a malicious service. When the pagination operations are different from what is expected when only legitimate services are running, an inference is made that some of the pagination operations are indicative of ransomware.

### FIELD OF THE INVENTION

Embodiments of the present invention generally relate to detection of ransomware. More particularly, at least some embodiments of the invention relate to systems, hardware, software, computer-readable media, and methods, for detection of ransomware using operating system (OS) pagination functions and operations.

### BACKGROUND

Ransomware that attacks a computing system will cause significant memory usage functionality. This is due to the fact that ransomware commonly employs processes such as reading files, and encrypting files. Because these activities are memory-based, that is, they rely on the use of memory for their implementation, these ransomware operations require memory capacity from the OS (operating system). Since the OS also needs to serve other services, it uses the built-in functionality of pagination, by which the OS moves “snapshots,” or pages, of the memory section(s) used by the service(s) into disk space.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1a discloses aspects of an example operating environment for one embodiment of the invention.

FIG. 1b discloses aspects of initial states of a memory space, and a pagination disk space.

FIG. 2 discloses aspects of memory space used by services, and a pagination disk space not utilized by the services.

FIG. 3 discloses memory and pagination disk space usage before, and after, a service uses the pagination disk space.

FIG. 4 discloses the progressive use of memory and pagination disk space by services, and ransomware.

FIG. 5 discloses the return of a service to memory space, and the use of disk space by another service and by ransomware.

FIG. 6 discloses the consumption of memory space and some pagination disk space by ransomware, and a service again moved out of memory space to pagination disk space.

FIG. 7 discloses a method according to one example embodiment.

FIG. 8 discloses an example computing entity configured and operable to perform any of the disclosed methods, processes, and operations.

### DETAILED DESCRIPTION OF SOME EXAMPLE EMBODIMENTS

Embodiments of the present invention generally relate to detection of ransomware. More particularly, at least some embodiments of the invention relate to systems, hardware, software, computer-readable media, and methods, for detection of ransomware using operating system (OS) pagination functions and operations.

In its normal operations, a service may require the use of memory space. However, the amount of memory space available to the service may be limited because other services also need to use the memory space. Thus, an OS controlling access to the memory space may, from time to time, take ‘snapshots’ of the portion of memory space being used by a service, and then move those snapshots, in a process sometimes referred to as ‘pagination,’ to a memory section in disk space that is devoted to that service. In this way, the OS may be able to retrieve processes, in the form of pages, from the pagination disk space into memory when needed by the service. An embodiment of the invention may leverage these pagination operations of the OS as a way to detect the presence of ransomware.

Because ransomware processes such as reading, and encrypting, files requires significant memory usage, the ransomware may be detected by monitoring the pagination operations performed by the OS. For example, and as discussed below in connection with the Figures, a running ransomware process may have significant effects on pagination operations. For example, the ransomware process may have the effect of moving legitimate services that might ordinarily be expected to consume the available memory space, to pagination disk space, and the memory space may be consumed, in whole or in part, by the ransomware process. In some instances, the ransomware process itself may consume some pagination disk space. By monitoring the use of memory space, and the pagination operations for legitimate services, an embodiment may detect the presence and operation of ransomware.

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that ongoing OS pagination processes performed in support of legitimate services may be leveraged to enable detection of ransomware and other similarly behaving malicious services. An embodiment may be fairly lightweight in terms of its impact on computing system resources. Various other advantages of some example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Aspects of an Example Architecture and Environment

The following is a discussion of aspects of example operating environments for various embodiments of the invention. This discussion is not intended to limit the scope of the invention, or the applicability of the embodiments, in any way.

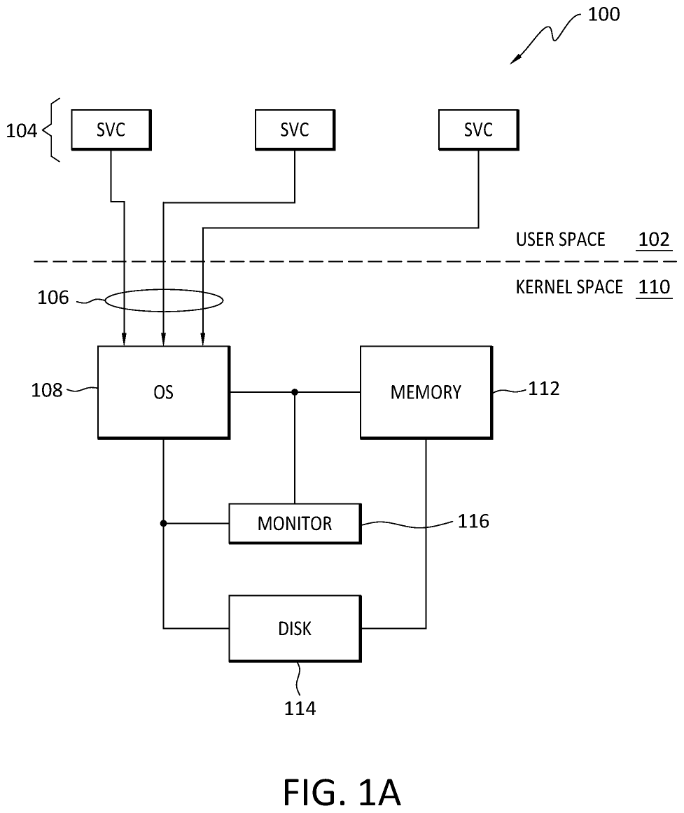

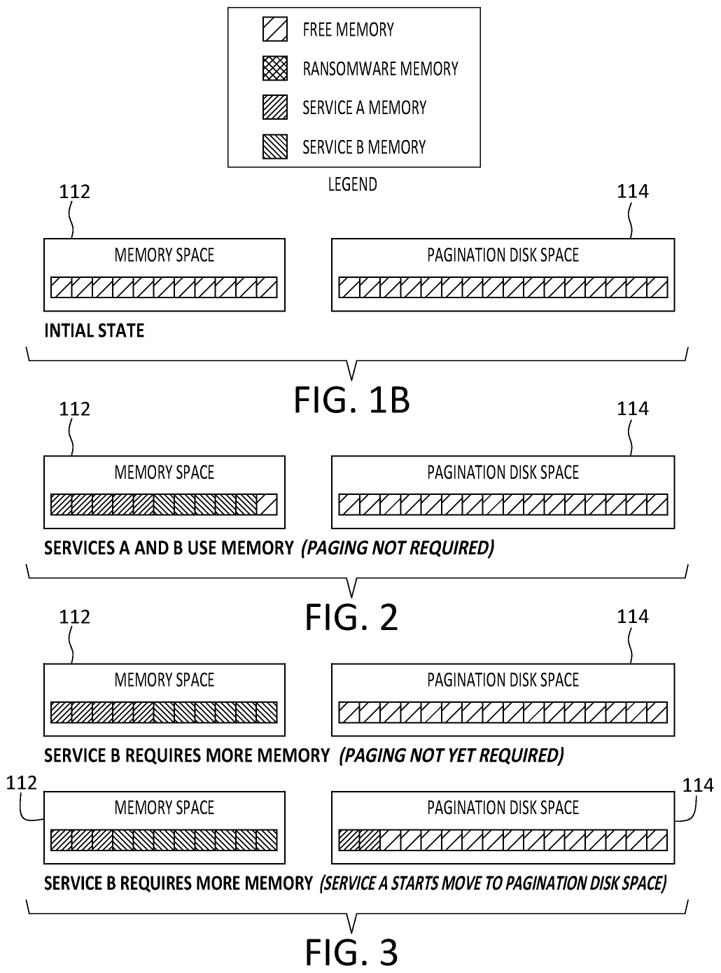

With particular attention to FIG. 1a, one example of an operating environment for embodiments of the invention is denoted generally at 100. In general, the operating environment 100 may comprise a Linux® operating environment, but the scope of the invention is not limited to any particular operating environment. Thus, while reference may be made herein to a Linux® environment and processes, such references are made for the purpose of illustration and are not intended to limit the scope of the invention in any way.

As shown in FIG. 1a, the example operating environment 100 may include a user space 102 in which various services 104, which may comprise or be in the form of one or more applications, are running. One or more of the services 104 may be legitimate services, and one or more of the services 104 may be ransomware or some other malicious service that has been introduced into the user space 102. In order to carry out their operations, which may include file read operations and file write operations, the services 104 may send calls 106 to an OS 108, operating in a kernel space 110, for access to various resources in the kernel space 110, or accessible from the kernel space 110. Such resources may include, for example, memory 112, and disk space 114.

As part of servicing the various calls 106, whether from legitimate, or malicious, services 104, the OS 108 may from time to time, take ‘snapshots’ of the portion of memory space 112 being used by a service 104, and then move those snapshots, as part of a pagination process, to a memory section in the disk space 114 that is devoted to that particular service 104. In this way, the OS 108 may be able to retrieve processes, in the form of pages, from the pagination disk space 113 into memory 112 when needed by the service 104.

In an embodiment, a monitor 116, which may comprise a module, is configured and arranged to monitor pagination processes performed by the OS 108 with respect to the memory 112 and disk space 114. While not specifically shown in FIG. 1a, the monitor 116 may periodically report on those pagination processes to a computing entity and/or to a human user.

In an embodiment, the information received by the monitor 116 may trigger the automatic performance of various operations. Such operations may include, for example, refusal to service further calls 106 from a service 104 identified as actual, or possible, ransomware. Such operations may include reporting the information gathered by the monitor 116.

As shown in the example of FIG. 1b, an initial state of the memory 112, and disk space 114, may be to be empty. In general, the disk space 114 may be relatively larger than the memory 112, although that is not necessarily required.

### B. Aspects of an Example Embodiment

With reference next to the examples disclosed in FIGS. 2-6, details are provided concerning some example pagination operations as they may relate to the use of memory 112 and/or disk space 114 by one or more of the services 104. In the examples of FIGS. 2-6, a progressive use of memory space 112 and disk space 114 is disclosed. It should be understood however, that this progression is provided by way of illustration and, as a practical matter, the various ways in which memory space 112 and/or disk space 114 may be used, and released, in pagination processes, including those processes involving the operation of ransomware, may be limitless.

Turning first to FIG. 2, it can be seen that the memory space 112 is partially consumed by two services, service A and service B in this example, and some of the memory space 112 is unutilized. Note that while two services are referred to in the examples of FIGS. 2-6, that is for the purposes of illustration and simplicity and, in a real-world situation, many more services may be involved.

As pagination operations continue to be performed in response to calls from services and/or applications, it can be seen, with reference now to FIG. 3, that service B has used up the remaining memory space 112 (compare FIG. 2) is using more memory space 112 than is used by service A. Note that at this point, no pagination disk space 114 has yet been consumed by either service A or service B. As service B continues to use memory space 112, and with continued reference to FIG. 3, service B may increase its share, relative to service A, of memory space 112, thus requiring movement of service A data to pagination disk space 114.

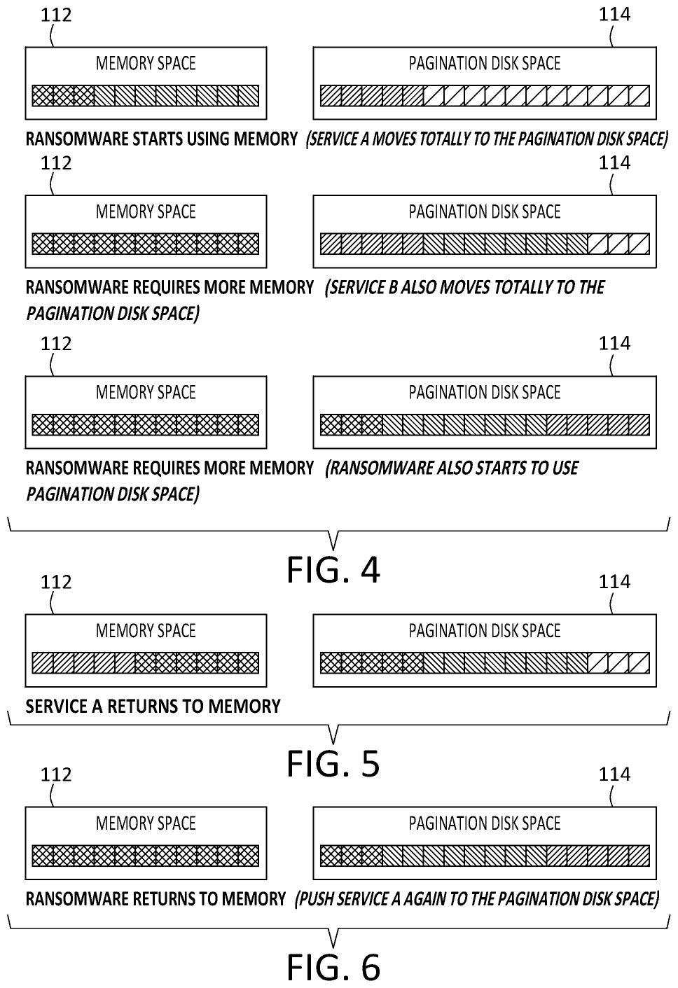

With reference next to FIG. 4, a progression is shown in which ransomware starts to consume memory space 112, at the expense of service A and service B. In particular, after the ransomware first begins to consume memory space 112, the service A data is pushed out of the memory space 112 to pagination disk space 114, and the share of memory space 112 used by service B remains initially unchanged.

However, and with continued reference to FIG. 4, as the ransomware continues to consume memory space 112, the data of service B, similar to the data of service A, is moved entirely to the pagination disk space 114. At this point, all of the memory space 112 is used up by the ransomware, and the service A data and service B data all resides in the pagination disk space 114. Thus, and due at least in part to the user of memory space 112 by the ransomware, the amount of pagination disk space 114 consumed by services A and B has exceeded what would be expected from normal operations of only those services. Further, and again due at least in part to the consumption of memory space 112 by the ransomware, the total amount of pagination disk space 114 has been consumed relatively more quickly than would otherwise be expected, absent operation of the ransomware. Thus, these examples indicate that the volume, and/or pace, of pagination operations has exceeded what might be expected for normal operations of only service A and service B.

With continued reference to FIG. 4, the operation of the ransomware is such that it begins to consume pagination disk space 114, to the extent that the pagination disk space 114 is now fully consumed (bottom diagram in FIG. 4) amongst the ransomware, and services A and B. Note that because services A and B have been forced to resort to use of the pagination disk space 114 by the operation of the ransomware, the speed and operation of those services A and B may be compromised.

Turning next to the example of FIG. 5, it can be seen that service A data has returned to the memory 112 from the pagination disk space 114, at the expense of the ransomware, while more of the ransomware data has moved to the pagination disk space 114. Some of the pagination disk space 114 has been freed up by movement of the service A data to the memory 112.

Finally, and directing attention now to FIG. 6, it can be seen that, again, all of the memory space 112, along with part of the pagination disk space 114, has been consumed by the ransomware. Correspondingly, all the service A and service B data has been pushed to the pagination disk space 114.

The examples of FIGS. 2-6 thus illustrate some effects that ransomware operations may have on the pace and timing of memory 112 and pagination disk area 114 consumption. These examples also illustrate the effect that ransomware may have on the operations of services A and B. Thus, by tracking pagination operations, and their attributes, as illustrated by the examples in FIGS. 2-6, an embodiment may be able to detect the presence and operation of ransomware. That is, monitoring the OS pagination activity may enable detection of malicious services such as ransomware, since those malicious services may cause significant pagination activities in the manner shown in the examples of FIGS. 2-6. In this way, an embodiment may implement, and use, a ransomware detection vector, possibly in combination with other ransomware detection vectors.

### C. Example Methods

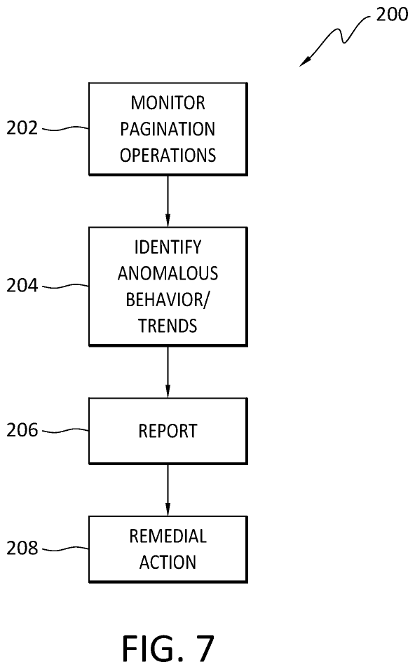

It is noted with respect to the disclosed methods, including the example method of FIG. 7, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Directing attention now to FIG. 7, an example method according to one embodiment is denoted at 200. The example method 200 may, in an embodiment, be performed within a kernel space, such as of a Linux® based system for example, although that is not necessarily required. The example method 200 may be performed by a dedicated monitoring module operating in a kernel space, and configured to communicate with, or at least monitor, an OS which may also be operating in the kernel space. The module may monitor, for example, communications between the OS and memory, and between the OS and disk space.

The example method 200 may begin at 202 where pagination operations performed and/or directed, by an OS, are monitored. Various attributes of the pagination operations may be monitored. Such attributes may include, but are not limited to, any grouping of one or more of: the pace of pagination operations, such as pagination operations/second (or other time reference); changes in the pace of pagination operations, where sudden and/or significant changes may indicate ransomware operations; the volume of pagination operations, where a large volume of pagination operations in a defined time period may indicate ransomware operations; the amount of consumed memory space and/or consumed pagination disk space that cannot be attributed to known legitimate processes; the amount of time required for memory and/or disk space to fill with pages, where relatively rapid filling of memory and/or disk space may indicate ransomware operations; the number of times, within a set time period, that pages switch between the memory and the disk space; the number of pages that switch between the memory and the disk space; and, the amount of time that pages spend in memory and/or disk space; the amount of memory and/or disk space in use at any given time. Various other possible pagination attributes that may be monitored, or derived from the foregoing attributes, will be apparent from this disclosure, and knowledge available in the art.

The method 200 may then proceed to 204 where the pagination operations, and one or more attributes may be analyzed to identify any anomalous behavior and/or trends. In an embodiment, the analysis at 204 may be performed on-the-fly, in real time, as pagination operations are occurring. In this way, an embodiment may timely identify possible ransomware operations. Additionally, or alternatively, the analysis at 204 may be performed at regularly scheduled time intervals, or on an ad hoc basis.

The outcome of any analyses 204 may be reported 206 to a computing entity, and/or to a human. As with performance of the analyses 204, the reporting 206 may be performed on-the-fly, in real time, as analyses 204 are completed. Additionally, or alternatively, the reporting 206 may be performed at regularly scheduled time intervals, or on an ad hoc basis. The reporting 206 may include generation of reports that may be stored, and possibly used for training an AI/ML model to detect ransomware processes by pagination monitoring.

Finally, the method 200 may identify and/or implement various remedial actions 208 pertaining to ransomware that may have been identified in the analysis 204. The remedial actions 208 may generally involve halting the identified, or suspected, ransomware process. For example, a remedial action may include refusing to service or accept further calls from the ransomware, or preventing application access to memory and/or pagination disk space.

### D. Further Example Embodiments

Following are some further example embodiments of the invention. These are presented only by way of example and are not intended to limit the scope of the invention in any way.

Embodiment 1. A method, comprising: monitoring pagination operations of an operating system; collecting information about the pagination operations; analyzing the information about the pagination operations; and based on the analyzing, determining whether any of the pagination operations are indicative of a malicious service.

Embodiment 2. The method as recited in any of the preceding embodiments, wherein the pagination operations are associated with a legitimate service, and the malicious service.

Embodiment 3. The method as recited in any of the preceding embodiments, wherein the malicious service comprises ransomware.

Embodiment 4. The method as recited in any of the preceding embodiments, wherein the operations are performed in a kernel space.

Embodiment 5. The method as recited in any of the preceding embodiments, wherein an outcome of the analyzing is reported to a computing entity and/or to a human.

Embodiment 6. The method as recited in any of the preceding embodiments, wherein the pagination operations concern use of memory, and use of pagination disk space.

Embodiment 7. The method as recited in any of the preceding embodiments, wherein when the pagination operations are different from what is expected when only legitimate services are running, an inference is made that some of the pagination operations are indicative of ransomware.

Embodiment 8. The method as recited in any of the preceding embodiments, wherein the pagination operations indicate use, by ransomware, of memory and/or pagination disk space.

Embodiment 9. The method as recited in any of the preceding embodiments, wherein the analyzing is performed in real time as pagination operations are taking place.

Embodiment 10. The method as recited in any of the preceding embodiments, wherein the pagination operations relate to the operation of one or more services running in a userspace.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### E. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

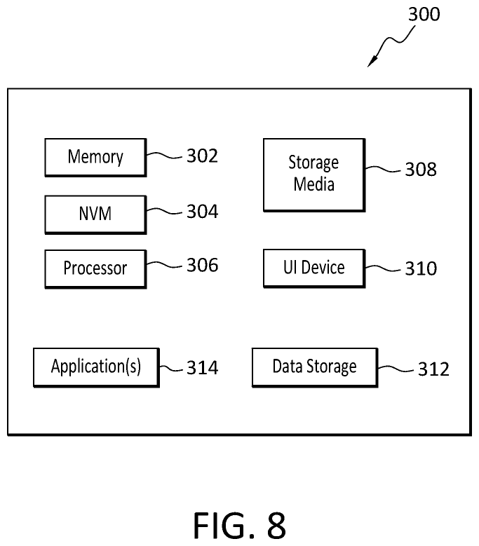

With reference briefly now to FIG. 8, any one or more of the entities disclosed, or implied, by FIGS. 1-7, and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 8.

In the example of FIG. 8, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 30 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising operations including:
monitoring pagination operations of an operating system;
collecting information about the pagination operations;
analyzing the information about the pagination operations; and
based on the analyzing, determining whether any of the pagination operations are indicative of a malicious service.

2. The method as recited in claim 1, wherein the pagination operations are associated with a legitimate service, and the malicious service.

3. The method as recited in claim 1, wherein the malicious service comprises ransomware.

4. The method as recited in claim 1, wherein the operations are performed in a kernel space.

5. The method as recited in claim 1, wherein an outcome of the analyzing is reported to a computing entity and/or to a human.

6. The method as recited in claim 1, wherein the pagination operations concern use of memory, and use of pagination disk space.

7. The method as recited in claim 1, wherein when the pagination operations are different from what is expected when only legitimate services are running, an inference is made that some of the pagination operations are indicative of ransomware.

8. The method as recited in claim 1, wherein the pagination operations indicate use, by ransomware, of memory and/or pagination disk space.

9. The method as recited in claim 1, wherein the analyzing is performed in real time as pagination operations are taking place.

10. The method as recited in claim 1, wherein the pagination operations relate to the operation of one or more services running in a userspace.

11. A non-transitory storage medium having stored therein instructions that are executable by one or more hardware processors to perform operations comprising:
monitoring pagination operations of an operating system;
collecting information about the pagination operations;
analyzing the information about the pagination operations; and
based on the analyzing, determining whether any of the pagination operations are indicative of a malicious service.

12. The non-transitory storage medium as recited in claim 11, wherein the pagination operations are associated with a legitimate service, and the malicious service.

13. The non-transitory storage medium as recited in claim 11, wherein the malicious service comprises ransomware.

14. The non-transitory storage medium as recited in claim 11, wherein the operations are performed in a kernel space.

15. The non-transitory storage medium as recited in claim 11, wherein an outcome of the analyzing is reported to a computing entity and/or to a human.

16. The non-transitory storage medium as recited in claim 11, wherein the pagination operations concern use of memory, and use of pagination disk space.

17. The non-transitory storage medium as recited in claim 11, wherein when the pagination operations are different from what is expected when only legitimate services are running, an inference is made that some of the pagination operations are indicative of ransomware.

18. The non-transitory storage medium as recited in claim 11, wherein the pagination operations indicate use, by ransomware, of memory and/or pagination disk space.

19. The non-transitory storage medium as recited in claim 11, wherein the analyzing is performed in real time as pagination operations are taking place.

20. The non-transitory storage medium as recited in claim 11, wherein the pagination operations relate to the operation of one or more services running in a userspace.
